(19) United States
(12) Patent Application Publication
(10) Pub. No.: US 2020/0130215 A1
(43) Pub. Date: Apr. 30, 2020

(54) METHOD FOR MANUFACTURING AND ATTACHING A SCREEN PROTECTOR FOR SMART DEVICES

(71) Applicant: Kab Sung Chong, Seoul (KR)

(72) Inventor: Kab Sung Chong, Seoul (KR)

(21) Appl. No.: 16/192,839

(22) Filed: Nov. 16, 2018

(30) Foreign Application Priority Data
Oct. 31, 2018 (KR) 20-2018-0004921

(51) Int. Cl. B26D 3/10; B26F 1/44

(52) U.S. Cl. CPC B26D 3/10; G06F 3/14; B26F 1/44

(57) ABSTRACT

Providing a method for manufacturing a screen protector comprised of a step of forming the first physical pattern on the screen protector; a step of preparing the web page which stores the electronic pattern corresponding to the first physical pattern; a step of indicating the display information that can display the web page on the screen protector with the characteristic that the first physical pattern is a kiss-cut pattern.

### CROSS REFERENCE

This application claims priority to Korean patent application number 20-2018-0004921 filed on Oct. 31, 2018. The disclosure thereof is incorporated herein by reference in its entirety.

### TECHNICAL FIELD

This invention is for a method of forming a screen protector, a system which provides a screen protector, and a method of attaching a screen protector.

### BACKGROUND OF INVENTION

A screen protector protects the liquid crystal display (LCD) by being attached to the LCD of smart devices (Smart Phone, Tablet PC). A screen protector includes a transparent film, which is attached to the LCD, and a cover sheet that is attached to the transparent film. The cover sheet is to be removed when the screen protector is attached to the LCD.

The screen protector has to be attached to an exact location on an LCD. If there is any mistake in the location of attachment of the screen protector, the camera lens, speaker, home button, etc. may be covered by the screen protector and it may become impossible to use the smart device properly.

A guide line and a base line will be created for alignment. The guide line is formed on the smart device and the base line is printed on the screen protector. Thus far, the guide lines provided on smart devices have functioned as a master pattern and the base lines provided on screen protectors have functioned as a slave pattern. The base line provided on the screen protector is embodied physically. Thus, if the guide line provided on a smart device is determined first, there is no degree of freedom in the production process that forms the base line on the screen protector. The base line had to physically correspond to the predetermined guide line with pinpoint accuracy.

It is very difficult for a production process to form a physical base line exactly on a certain location. As a result, the defect rate was high and the production costs increased accordingly. In addition, the location of the base line printed on the screen protector would differ each time as the location of the guide line would change according to the type of the smart device. As a result, production work became complicated and the production costs increased.

### DETAILED DESCRIPTION OF THE INVENTION

### Problems to be Solved

This invention provides a method for manufacturing a screen protector that can save production costs through a low defect rate. It also provides a method and system for easy, quick, and accurate attachment of a screen protector to a smart device.

### Solution to Solve the Problems

A method for the formation of a screen protector according to this invention includes a step wherein a first physical pattern is formed on the screen protector; a step wherein an electronic pattern, which corresponds with the first physical pattern, is prepared on a web page; and a step wherein display information is provided for display on the web page. The first physical pattern is a kiss-cut pattern. The screen protector and the display information are provided pairwise. The first physical pattern functions as the master pattern and the electronic pattern functions as the slave pattern. In other words, the first physical pattern is determined first and the electronic pattern is formed later to correspond to the already determined first physical pattern.

The first physical pattern is a kiss-cut pattern. The electronic pattern is saved in the web page to be able to be loaded onto a smart device using the display information. The first physical pattern and the electronic pattern are used for the alignment of the screen protector with the smart device.

A method for the formation of the screen protector may include the additional stage of cutting the screen protector. The first physical pattern is formed in a step of cutting the screen protector material. The screen protector includes the transparent film and cover sheet. The detachable cover sheet is to be attached to one side or both sides of the transparent film. The screen protector is cut while the cover sheet is attached to the transparent film. The process of cutting the screen protector and the process of making the kiss-cut pattern are performed at the same time.

The method for the formation of screen protector may include a step of forming the additional second physical pattern to the screen protector. In this case, the electronic pattern includes the first pattern and the second pattern. The first physical pattern corresponds with the first pattern and the second physical pattern corresponds with the second pattern.

The system which provides the screen protector according to a representation of this invention includes the screen protector comprising the first physical pattern; the web page comprising the electronic pattern; and the display information which connects the first physical pattern and the electronic pattern. The display information is set to display the web page. The first physical pattern is a kiss-cut pattern. The screen protector and the display information are provided pairwise.

The screen protector comprising the first physical pattern and display information and the web page comprising the electronic pattern are included. The display information is set to display the web page. The first physical pattern is a kiss-cut pattern. The electronic pattern is stored in the web page to be able to be loaded on a random smart device using the display information.

A method for attachment of a screen protector according to a representation of the invention is comprised of a step of preparing the screen protector including the first physical pattern; a step of preparing the display information; a step of using the web page wherein the electronic pattern is stored using the display information and displaying the electronic pattern on the screen of the smart device; a step of aligning the screen protector and the screen of the smart device to correspond to the first physical pattern and the electronic pattern; and a step of attaching the screen protector to the screen of the smart device. The screen protector includes the transparent film and the cover sheet. The first physical pattern can be formed on the cover sheet. The first physical pattern is a kiss-cut pattern.

### Advantages of the Invention

According to this invention, the first physical pattern or the second physical pattern formed on the screen protector functions as the master pattern and the electronic pattern provided for the smart device functions as the slave pattern. The first or second physical pattern is determined first and the electronic pattern is formed later to correspond to the already determined first or second physical pattern.

Therefore, the production process which forms the first or the second physical pattern has a high degree of freedom in the production process. The degree of freedom in the production process of the electronic pattern is limited in that it has to be formed to correspond to the already formed physical pattern. However, unlike the physical pattern, the electronic pattern's structure can be formed and transformed as it is formed through programming, etc. Therefore, the production process of forming the electronic pattern also has a high degree of freedom in the production process. This invention can remarkably reduce the defect rate while attaining a high degree of freedom in the production process.

On the contrary, in existing technologies, the guide line of the electronic pattern is determined first and the base line of the physical pattern is formed later. As a result, the degree of freedom in the production process of forming the physical pattern is low while sustaining a high defect rate. For example, let's assume a case in which it was intended to print a square physical pattern on the screen protector but a rectangular pattern was printed due to an error in the production process of a certain batch. In the past, all of the screen protectors produced in this way would have to be disposed of as defective products.

However, through the application of this invention, the screen protectors produced in that batch can be used as normal products through reprogramming the electronic pattern to use a rectangular patter. The square physical pattern can be connected with the square electronic pattern through the first display information and the rectangular physical pattern can be connected with the rectangular electronic pattern through the second display information.

### BRIEF DESCRIPTION OF DRAWINGS

FIG. 1 shows the screen protector according to a representation of this invention.

FIG. 2 shows the smart device according to a representation of this invention.

FIG. 3 is the cross-sectional diagram of the cover sheet according to this invention and shows the cover sheet with a kiss-cut pattern according to a representation of this invention.

FIG. 4 is the cross-sectional diagram of the cover sheet presented for comparison and shows the cover sheet with a die-cut pattern.

FIG. 5 shows the system which provides the screen protector according to this invention.

### BEST MODE

Hereinafter, a representation of this invention is explained by referring to the attached drawings. Drawing 1 shows the screen protector (1) according to a representation of this invention. The screen protector (1) includes the transparent film (10) and the cover sheet (20). The screen protector (1) is formed by cutting synthetic resin or tempered glass. Various sizes and shapes of screen protector (1) can be produced by adjusting the cutting line (205).

The first physical pattern (201) and the second physical pattern (101) are formed in the cover sheet (20). The cover sheet (20) can be formed using transparent material such as transparent plastic or tempered glass. The first physical pattern (201) is a kiss-cut pattern. The second physical pattern (101) can be formed by printing point, line, figure, character, number, sign, or any combination thereof on the cover sheet (20). The display information (401) is formed on the cover sheet (20). The display information (401) may be QR code.

The first physical pattern (201) is a kiss-cut pattern formed by the production process of a kiss-cut pattern. Hereinafter, the first physical pattern (201) and the kiss-cut pattern (201) are of the same formation, and will be referred to as having the same meaning. The step of cutting the screen protector (1) and the step of kiss-cut forming the first physical pattern (201) on the cover sheet (20) may be performed at substantially the same time. The production process can be simplified if these steps are performed at the same time. As a result, it is possible to save production cost and reduce errors in the production process.

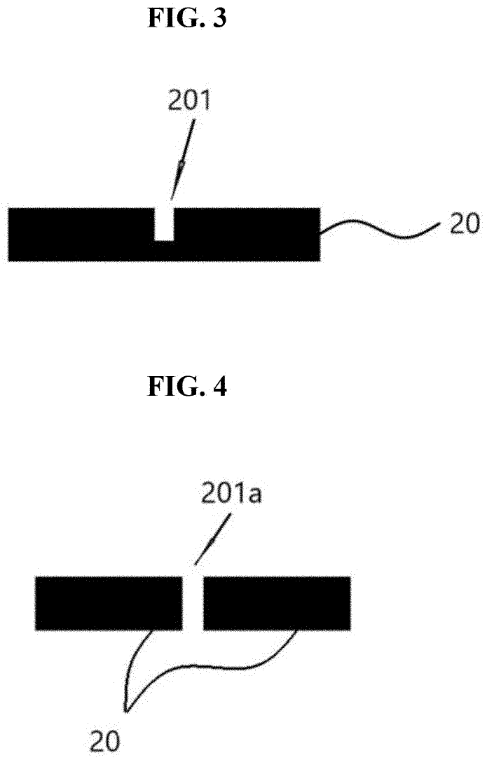

FIG. 3 is a cross-sectional diagram of a cover sheet (20) in which the kiss-cut pattern (201) is formed. FIG. 4 shows a cover sheet (20) in which the cutting pattern (201a) is formed. The cutting pattern (201a) forms a groove which penetrates the cover sheet (20). That is, the depth of the groove which is formed by the cutting pattern (201a) is the same as the thickness of the cutting pattern (201a). In contrast, the depth of the groove formed by the kiss-cut pattern (201) is less than the thickness of the cover sheet (20).

The cutting process and the kiss-cut production process are performed while the transparent film (10) and the cover sheet (20) are attached together. Therefore, the transparent film (10) is damaged if the cutting pattern (201a) is formed on the cover sheet (20). Refer to FIG. 4. In contrast, the first physical pattern (201) can be formed without damaging the transparent film (10) if a kiss-cut production process is used. The first physical pattern (201) obtained via the kiss-cut production process is used as the standard for the alignment of the screen protector (1).

FIG. 2 shows a smart device (3) according to a representation of this invention. More specifically, FIG. 2 shows the status of the electronic pattern (301) loaded onto the Liquid Crystal Display (or LCD) of the smart device (3). According to the representation, the electronic pattern (301) includes the first pattern (301a) and the second pattern (301b). The first pattern (301a) corresponds to the first physical pattern (201). The second pattern (301b) corresponds to the second physical pattern (101). In an additional representation, the electronic pattern (301) may not include the second pattern (301b) while still including the first pattern (301a). Also, in another additional representation, the electronic pattern (301) may not include the first pattern (301a) while still including the second pattern (301b).

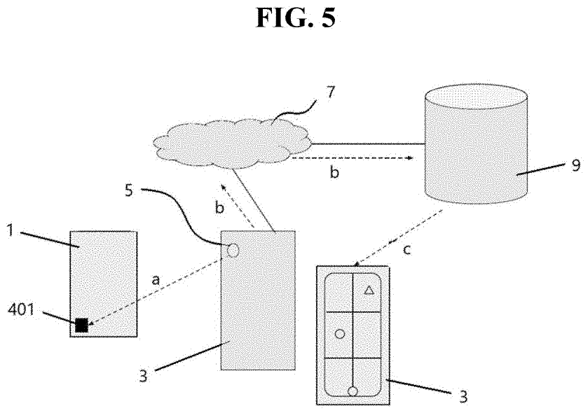

FIG. 5 shows the system which provides the screen protector according to this invention. The electronic pattern (301) is stored on the website (9). The website can be displayed by a smart device (3) using the display information (401). If the website (9) is displayed, the electronic pattern (301) is loaded on the screen of the smart device (3). The website (9) can be stored on a server(S).

Hereinafter, a method for the formation of a screen protector according to a representation of this invention is explained. A method for the formation of a screen protector according to a representation of this invention includes a step wherein the first physical pattern (201) is formed in the screen protector; a step wherein the electronic pattern (301) corresponds to the first physical pattern (201) while the web page (9) storing the electronic pattern (301) is being prepared; and a step wherein the display information that can display the web page is provided and wherein the screen protector and the display information are provided pairwise.

The first physical pattern (201) is a kiss-cut pattern as shown in FIG. 3. The method may include an additional step of cutting the screen protector material. A step of forming the first physical pattern (201) and a step of cutting the screen protector material may be performed at substantially the same time.

The meaning of the provision of the screen protector and the display information pairwise is that the display information may be embedded in the screen protector or may be provided separately from the screen protector.

First, an explanation regarding the step of cutting the screen protector material and the step of forming the first physical pattern (201) in the screen protector (1). The screen protector (1) includes the transparent film (10) and the cover sheet (20). The transparent film (10) can be made with polyethylene terephthalate (PET), thermoplastic polyurethane (TPU), polyvinyl alcohol (PVA), tempered glass, etc., but is not limited to these materials. The cover sheet (20) can be made with PET, but is not limited to this material.

The detachable cover sheet (20) is to be attached to one side or both sides of the transparent film (10). The cover sheet (20) may be formed with transparent material, in whole or in part. What is desirable is forming the kiss-cut pattern (201) with the transparent material.

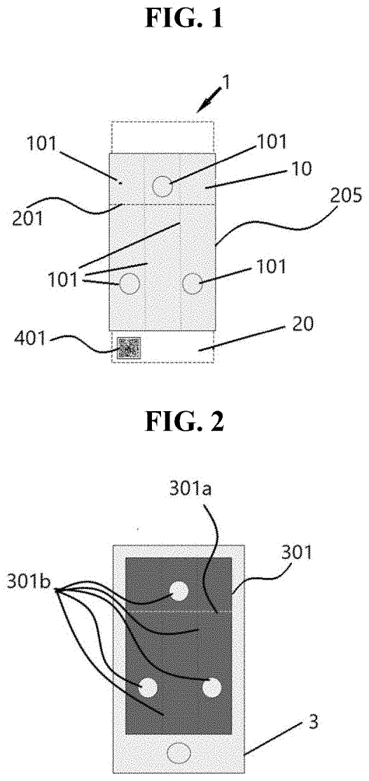

In a representation, PET is used for the cover sheet (20) and tempered glass is used for the transparent film (10). The screen protector (1) shown in FIG. 1 is obtained by cutting the PET sheet and the tempered glass sheet along the cutting line (205) while the PET sheet is attached to the tempered glass sheet. At this time, the kiss-cut production process and the material cutting process are performed concurrently. The screen protector (1) in which the kiss-cut pattern (201) is formed is obtained when the cutting process is completed. Refer to FIG. 1.

In an additional representation, an additional second physical pattern (101) can be formed on the cover sheet (20). The second physical pattern (101) may be formed before, after, or at the same time as the formation of the first physical pattern (201). The second physical pattern (101) may be composed of point, line, figure, character, picture, sign, or any combination thereof. The second physical pattern (101) can be formed by a method of printing on the cover sheet (20).

Next is the explanation of a step for preparing the web page (9) which stores the electronic pattern (301). The electronic pattern (301) is formed in a shape corresponding to the first physical pattern (201). The electronic pattern (301) has a high degree of freedom in the production process as it is formed through programming. Therefore, it is easy to program the electronic pattern (301) to correspond to a transformed first physical pattern (201) even if the first physical pattern (201) is formed differently from the original intention. The electronic pattern (301) is stored on a web page (9).

In an additional representation, the electronic pattern (301) may include the first pattern (301a) and the second pattern (301b). The first pattern (301a) corresponds to the first physical pattern (201) and the second pattern (301b) corresponds to the second physical pattern (101).

Next is an explanation of a step of the indication of the display information (401) on the screen protector (1). The display information (401) that can display the web page (9) is indicated on the screen protector (1). As shown in FIG. 1, the display information (401) can be indicated on the cover sheet (20). In an additional representation, the display information (401) can be indicated on the wrapping paper of the screen protector (1), etc. In another additional type of representation, the display information can be delivered via a separate document and can be delivered to the customer who purchased the screen protector (1) through various communication methods including e-mail, SMS, or telephone call.

The first physical pattern (201) and the electronic pattern (301) are connected to each other through the display information (40). The consumer who purchased the screen protector (1) displays the first physical pattern (201) using the display information (401). Once the web page (9) is displayed, the electronic pattern (301) is loaded onto the screen of the smart device (3).

As shown in FIG. 1, the display information (401) may be QR code. The consumer who purchased the screen protector (1) displays the web page (9) by tagging or taking a photo of the QR code with a smart device (3). As a result, the electronic pattern (301) stored on the web page (9) is loaded onto the screen of the smart device (3). In an additional representation, the display information (401) may be QR code, bar code, a web page URL, or any combination thereof. The display information (401) is not limited to these examples. Any technology that can load the electronic pattern (301) on the screen of the smart device (3) through direct display of the web page can be used as the display information (401).

According to a representation of this invention, the display information (401) displays a specific web page directly. Compared to a method which loads a specific image by installing an application or through manual operation of the screen, it is simple in operation, faster in loading speed, and cheaper in system operation.

Once the consumer purchases the screen protector (1), the display information (401) is provided together with it. Using the display information (401), the consumer can load the electronic pattern (301) onto the screen of his/her smart device (3). It is possible to attach the screen protector( ) to a desired location on the smart device (3) using both the standard for alignment of the first physical pattern (201) and the electronic pattern (301).

The screen protector system according to a representation of this invention includes the screen protector (1) including the first physical pattern (201); the web page (9) including the electronic pattern (301); and the display information (401) which connects the first physical pattern (201) and the electronic pattern (301). The display information (401) is set to display the web page (9). The first physical pattern is a kiss-cut pattern. The screen protector (1) and the display information (401) are provided pairwise. The electronic pattern (301) is stored in the web page (9) to be able to be loaded onto a smart device (l) using the display information (401).

Hereinafter, a method of attaching the screen protector according to a representation of this invention is explained referring to FIG. 5. A method of attaching the screen protector according to a representation of this invention includes a step of preparing the screen protector (1) including the first physical pattern (201); a step of preparing the display information (401); a step of displaying the web page (9) wherein the electronic pattern (301) is stored using the display information (401) wherein the electronic pattern (301) is indicated on the screen of the smart device (3); a step of aligning the screen protector (1) and the screen of the smart device (3) to align the first physical pattern (201) with the electronic pattern (301); and a step of attaching the screen protector (1) to the screen of the smart device (3). The screen protector (1) includes a transparent film (10) and a cover sheet (20). The first physical pattern (201) may be formed on the cover sheet (20). The first physical pattern (201) is a kiss-cut pattern.

First, the screen protector (1), including the first physical pattern (201) and the display information (401), is prepared. Once the consumer purchases the screen protector (1), the display information (401) is provided together with it. The display information (401) may be embedded in the screen protector (1) or it may be provided separately. The display information (401) and the screen protector (1) are provided pairwise for the display of the electronic pattemrn (301) corresponding to the first physical pattern (201) using the display information (401).

The consumer displays the web page (9) using the display information (401). Specifically, the display information (401), a QR code for example, is scanned with a camera(S) connected with the smart device (3). Refer to (a) stage of FIG. 5. The web page (9) is displayed by transmitting the QR code (401) through a wired or wireless network (7). Refer to (b) stage of FIG. 5. Once the web page (9) is displayed, the electronic pattern (301) is indicated on the screen of the smart device (2). Refer to (c) stage of FIG. 5.

The first physical pattern (201) and the electronic pattern (301) may be designed differently according to the type of smart device (3). The display information (401) may include information regarding the type of device (identifier) which can identify the type of the smart device. It is possible to verify if the mutually connected first physical pattern (201) and the electronic pattern (301) are applied to the same type of smart device using the information regarding the type of the device.

Next, the screen protector (1) is aligned to the screen of the smart device (3) to align the first physical pattern (201) with the electronic pattern (301). In an additional representation, the alignment process can be conducted by aligning the second physical pattern (111) with the electronic pattern (301).

Once the alignment process is completed, the cover sheet (20) is removed while the location of the transparent film (10) is fixed, and the transparent film (10) is attached to the screen of the smart device (2). According to a representation, there is a layer of adhesive between the transparent film (10) and the cover sheet (20). Once the cover sheet (20) is removed, the transparent film (10) and the screen of the smart device (2) are attached together via the layer of adhesive.

As mentioned above, it is possible to secure a high degree of freedom in the process of forming the screen protector according to this invention. As a result, the defect rate can be reduced remarkably and production costs can be saved. In addition, the production process can be simplified by performing the step of the formation of the first physical pattern (201) and the material cutting process concurrently. Also, the user can attach the screen protector quickly, easily, and accurately.

### EXPLANATION ON NUMERICAL REFERENCES

1: Screen protector
10: Transparent film
20: Cover sheet
201: The first physical pattern (kiss-cut pattern)
201a: Cutting pattern
205: Cutting line
101: The second physical pattern
401: Display information
3: Smart device
301: Electronic pattern
301a: The first pattern
301b: The second pattern
5: Camera
7: Wired and wireless network
9: Web page

What is claimed is:

1. A method for manufacturing a screen protector, comprising:
a step of forming a first physical pattern on a screen protector;
a step of preparing a web page storing an electronic pattern, wherein the electronic pattern corresponds with the first physical pattern; and
a step of providing display information, wherein the display information calls the web page web page,
wherein the first physical pattern is a kiss-cut pattern,
wherein the screen protector and the display information are provided pairwise.

2. The method of claim 1, further comprising:
a step of cutting a film raw sheet to separate the screen protector from the film raw sheet,
wherein the step of forming the first physical pattern and the step of material cutting are performed substantially at the same time.

3. The method of claim 1,
wherein the screen protector includes a transparent film and a cover sheet,
wherein the cover sheet is attached to a first side of the transparent film in a detachable manner,
wherein the step of material cutting is performed while the cover sheet is attached to the transparent film,
wherein the step of forming the first physical pattern and the step of cutting are performed substantially at the same time.

4. The method of claim 1, further comprising:
a step of forming a second physical pattern on the screen protector,
wherein the electronic pattern includes a first pattern and a second pattern,
wherein the first physical pattern corresponds with the first pattern,
wherein the second physical pattern corresponds with the second pattern.

5. A system providing a screen protector, comprising:
a screen protector including a first physical pattern;
a web page including an electronic pattern; and
display information calling a webpage, wherein the webpage includes the electronic pattern,
wherein the electronic pattern corresponds with the first physical pattern,
wherein the first physical pattern is a kiss-cut pattern,
wherein the screen protector and the display information are provided pairwise.

6. A method for attaching a screen protector, comprising:
a step of preparing a screen protector including a first physical pattern;
a step of preparing display information;
a step of calling a web page using the display information to display an electronic pattern on a screen of the smart device, wherein the web page stores the electronic pattern;
a step of placing the screen protector on the screen of the smart device to align the first physical pattern to the corresponding electronic pattern; and
a step of attaching the screen protector to the screen of the smart device,
wherein the screen protector includes a transparent film and a cover sheet,
wherein the first physical pattern is provided on the cover sheet,
wherein the first physical pattern is a kiss-cut pattern.
